(19) United States
(12) Patent Application Publication
(10) Pub. No.: US 2007/0116956 A1
(43) Pub. Date: May 24, 2007

(54) MOLD HAVING MULTILAYER DIAMOND-LIKE CARBON FILM

(75) Inventor: GA-LANE CHEN, Santa Clara, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,494

(22) Filed: Aug. 11, 2006

(30) Foreign Application Priority Data
Nov. 18, 2005 (TW) 094140609

(51) Int. Cl. B32B 9/00

(52) U.S. Cl. 428/408

(57) ABSTRACT

An exemplary mold includes a main body, a doped diamond-like carbon composite film formed on the main body and an undoped diamond-like carbon film formed on the doped diamond-like carbon composite film. The doped diamond-like carbon composite film includes a number of doped diamond-like carbon layers stacked one on another. Each of the doped diamond-like carbon layers is composed of carbon, hydrogen and a filler component selected from a group consisting of metal and metal nitride. A content of the filler component in each doped diamond-like carbon layer gradually decreases with increasing distance away from the main body.

### CROSS-REFERENCE TO RELATED APPLICATIONS

This application is related to commonly-assigned co-pending applications (application Ser. No. 11/309,308) entitled, “ARTICLE WITH MULTILAYER DIAMOND-LIKE CARBON FILM”, filed on the 25th of July, 2006, and “ARTICLE WITH MULTILAYER DIAMOND-LIKE CARBON FILM”, filed ______ (Attorney. Docket No. US9307). Disclosures of the above identified applications are incorporated herein by reference.

### TECHNICAL FIELD

The present invention generally relates to a diamond-like carbon film, and more particularly relates to a mold having a diamond-like carbon film with graduated composition and multilayered structure.

### BACKGROUND

Diamond-like carbon film was first deposited by Aisenberg et al. and from then on a variety of different techniques for diamond-like carbon film deposition have been developed.

Diamond-like carbon is a mostly metastable amorphous material but can include a microcrystalline phase. Diamond-like carbon contains both sp² and sp³ hybridised carbon atoms. Diamond-like carbon includes amorphous carbon (a-C) and hydrogenated amorphous carbon (a-C:H) with significant sp³ bonding. The amorphous carbon where more than 85% of the carbon atoms form sp³ bonds is called highly tetrahedral amorphous carbon (ta—C). The sp³ bonding provides the diamond-like carbon film with valuable diamond-like properties such as mechanical hardness, low friction, optical transparency and chemical inertness. The diamond-like carbon film has some other advantages, such as being capable of deposition at room temperature, deposition onto a steel substrate, a plastic substrate, and superior surface smoothness.

Diamond-like carbon film can be used as a protective film of a mold because of excellent properties such as a corrosion resistance and a wear resistance. However, it is difficult for conventional diamond-like carbon film to adhere to the mold substrate because of residual stresses therein. Thus, the configuration leads to an unsatisfactory combination between the diamond-like carbon film and the mold substrate.

What is needed, therefore, is a mold having a diamond-like carbon film with good corrosion resistance, good wear resistance and high adhesion to the mold substrate.

### SUMMARY

One preferred embodiment provides a mold including a main body, a doped diamond-like carbon composite film formed on the main body and an undoped diamond-like carbon film formed on the doped diamond-like carbon composite film. The doped diamond-like carbon composite film includes a number of doped diamond-like carbon layers stacked one on another. Each of the doped diamond-like carbon layers is composed of carbon, hydrogen and a filler component selected from a group consisting of metal, metal alloy and metal nitride. A content of the filler component in each doped diamond-like carbon layer gradually decreases with increasing distance away from the main body.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of embodiments. Moreover, in the drawing, like reference numerals designate corresponding parts.

FIG. 1 is a schematic view of a mold having a doped diamond-like carbon composite film and an undoped diamond-like carbon film according to a preferred embodiment.

### DETAILED DESCRIPTION OF PREFERRED EMBODIMENTS

Embodiments will now be described in detail below and with reference to the drawings.

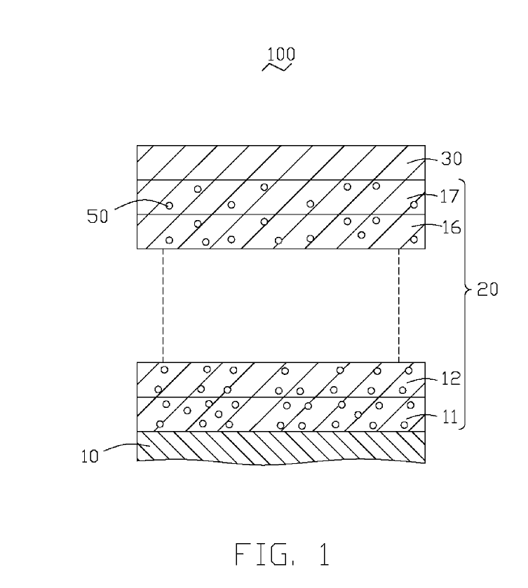

Referring to FIG. 1, a mold 100 including a main body 10, a doped diamond-like carbon composite film 20, and an undoped diamond-like carbon film 30 according to a preferred embodiment is shown. The doped diamond-like carbon composite film 20 has a graduated composition and is formed on the main body 10. The undoped diamond-like carbon film 30 is formed on the doped diamond-like carbon composite film 20.

The main body 10 can be made of mirror-polished stainless steel. The surface roughness (Ra) of the main body 10 should be less than 10 nanometers. The main body 10 can be a material selected from a group consisting of ferrum-carbon-chromium (FeCCr) alloy, ferrum-carbon-chromium-molybdenum (FeCCrMo) alloy, ferrum-carbon-chromium-vanadium-molybdenum (FeCCrVMo) alloy, and ferrum-carbon-chromium-vanadium-silicon-molybdenum (FeCCrVSiMo) alloy.

The doped diamond-like carbon composite film 20 includes n number of layers, i.e., a first layer 11, a second layer 12, . . . , a (n−1)th layer 16, and an nth layer 17 stacked one on top of the other in that order, wherein n is an integer preferably in a range from 5 to 30. The first layer 11 is an innermost layer of the doped diamond-like carbon composite film 20 that is adapted to adhere to the main body 10. The second layer 12 is formed on the first layer 11. Similarly, the (n−1)th layer 16 is the second layer counting from the outer layer of the doped diamond-like carbon composite film 20, and a nth layer 17 is formed on the (n−1)th layer 16. Particularly advantageously, the doped diamond-like carbon composite film 20 is formed directly on a molding surface of the main body 10, and each succeeding layer is directly formed on (i.e., in contact with) the layer preceding it in the series.

Each doped diamond-like carbon layer has a different composition. Each doped diamond-like carbon layer is composed of carbon, hydrogen and a filler component 50. The filler component 50 can be metal, metal alloy or metal nitride. The filler component 50 can be selected from a group consisting of chromium, titanium, zinc, chromium-titanium alloy, chromium nitride, titanium nitride, zinc nitride and any combination thereof. The filler component 50 in each doped diamond-like carbon layer gradually decreases in content from the first layer 11 to the nth layer 17. For example, if an mth layer is any one of the doped diamond-like carbon layers of the doped diamond-like carbon composite film 20, a composition of the mth layer can be represented by a formula of a-C:H:(n−m+1)X, wherein m is an integer in a range from 1 to n, C represents a carbon component, H represents a hydrogen component, and X represents a filler component. Therefore the composition of each doped diamond-like carbon layer can be represented by a formula, for example, the first layer 11 can be represented by a-C:H:nX, the second layer 12 can be represented by a-C:H:(n−1)X, . . . , the (n−1)th layer 16 can be represented by a-C:H:2X, and the nth layer 17 can be represented by a-C:H:X.

An atomic percentage of the filler component 50 in each doped diamond-like carbon layer gradually decreases from the first layer 11 to the nth layer 17. For example, the nth layer 17 in the doped diamond-like carbon composite film 20 has least atomic percentage of the filler component 50. The atomic percentage of the filler component 50 in the nth layer 17 is represented by xₙ, wherein xₙ is in a range from 0.2% to 1.0%. The atomic percentage of the filler component 50 in the mth layer is represented by xₘ, according to the formula of a-C:H:(n−m+1)X, the content of the filler component 50 in the mth layer is (n−m+1) times xₙ.

The filler component 50 can strengthen the diamond-like carbon layer, whilst the corrosion resistance and wear resistance of the diamond-like carbon layer are weakened. Therefore, the properties of each doped diamond-like carbon layer depend on the atomic percentage of the filler component 50 thereof. The first layer 11 in the doped diamond-like carbon composite film 20 has greatest atomic percentage of the filler component 50, therefore having lowest corrosion resistance and wear resistance. The nth layer 17 in the doped diamond-like carbon composite film 20 has least atomic percentage of the filler component 50, thereby having greatest corrosion resistance and wear resistance.

The first layer 11 is the innermost layer of the doped diamond-like carbon composite film 20 that is adapted to contact with the main body 10. The main body 10 is composed of a metal, thus an increased content of the metal-containing filler component 50 in the first layer 11 of the doped diamond-like carbon composite film 20 facilitates an adhesion to the main body 10. In other words, the doped diamond-like carbon composite film 20 adheres relatively easily to the main body 10.

The content of the filler component 50 in each doped diamond-like carbon layer gradually decreases from the first layer 11 to the nth layer 17, so that each doped diamond-like carbon layer can adhere to each other more tightly. The composition of the nth layer 17 of the doped diamond-like carbon composite film 20 is similar to the undoped diamond-like carbon film 30, thus, the undoped diamond-like carbon film 30 can adhere to the doped diamond-like carbon composite film 20 tightly.

The doped diamond-like carbon composite film 20 may have good corrosion resistance, adhesion, and wear resistance by optimizing the graduated composition of each doped diamond-like carbon layer thereof.

A thickness of each doped diamond-like carbon layer is in a range from 1 nanometer to 30 nanometers. In this embodiment, a thickness of the doped diamond-like carbon composite film 20 can be in a range from 5 nanometers to 900 nanometers. Preferably, the thickness of the doped diamond-like carbon composite film 20 should be in a range from 30 nanometers to 450 nanometers.

The undoped diamond-like carbon film 30 without any filler component is formed on the nth layer 17 of the doped diamond-like carbon composite film 20. The undoped diamond-like carbon film 30 has some excellent properties such as hardness, smoothness, corrosion resistance and wear resistance, etc. A thickness of the undoped diamond-like carbon film 30 can be in a range from 1 nanometer to 10 nanometers. Preferably, the thickness of the undoped diamond-like carbon film 30 should be in a range from 2 nanometers to 5 nanometers.

Therefore, the total thickness of the whole film including the doped diamond-like carbon composite film 20 and the undoped diamond-like carbon film 30 can be in a range from 6 nanometers to 910 nanometers. Preferably, the total thickness of the whole film including the doped diamond-like carbon composite film 20 and the undoped diamond-like carbon film should be from 30 to 500 nanometers.

The doped diamond-like carbon composite film 20 and the undoped diamond-like carbon film 30 can be deposited by radio frequency (RF) diode sputtering or radio frequency magnetron sputtering. The doped diamond-like carbon composite film 20 is deposited on the main body 10 of the mold 100 in vacuum environment in a radio frequency sputtering process. Firstly, the main body 10, a carbon target and a filler component target in a radio frequency sputtering system are placed in position, and then sputter gas is fed into the radio frequency sputtering system. Secondly, the doped diamond-like carbon composite film 20 is formed using a sputtering process. The atomic percentage of the filler component 50 in each doped diamond-like carbon layer should gradually decrease from the first layer 11 to the nth layer 17. Finally, the filler component target is removed from the radio frequency sputtering system and the undoped diamond-like carbon film 30 is formed.

The sputter gas into the radio frequency sputtering system can be selected from a group consisting of a mixture of argon and methane (where a percentage by volume of methane is in a range from 5% to 20%), a mixture of argon and hydrogen (where a percentage by volume of hydrogen is in a range from 5% to 20%), a mixture of argon and ethane (where a percentage by volume of ethane is in a range from 5% to 20%), a mixture of krypton and methane (where a percentage by volume of methane is in a range from 5% to 20%), a mixture of krypton and hydrogen (where a percentage by volume of hydrogen is in a range from 5% to 20%), and a mixture of krypton and ethane (where a percentage by volume of ethane is in a range from 5% to 20%).

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A mold, comprising:
a main body;
a doped diamond-like carbon composite film formed on the main body, the doped diamond-like carbon composite film comprising a plurality of doped diamond-like carbon layers stacked one on another, each of the doped diamond-like carbon layers being composed of carbon, hydrogen and a filler component selected from a group consisting of metal, metal alloy and metal nitride, a content of the filler component in each doped diamond-like carbon layer gradually decreasing with increasing distance away from the main body; and
an undoped diamond-like carbon film formed on the doped diamond-like carbon composite film.

2. The mold as claimed in claim 1, wherein the doped diamond-like carbon composite film comprises a first layer configured to adhere to the main body and an nth layer configured to adhere to the undoped diamond-like carbon film, with the other layers sandwiched between the first layer and the nth layer, the content of the filler component in each doped diamond-like carbon layer gradually decreasing from the first layer to the nth layer.

3. The mold as claimed in claim 1, wherein the doped diamond-like carbon composite film comprises a number of n layers of the doped diamond-like carbon layers, wherein n is in a range from 5 to 30.

4. The mold as claimed in claim 2, wherein an atomic percentage of the filler component in the nth layer of the doped diamond-like carbon composite film is represented by xₙ which is in a range from 0.2% to 1%, wherein n is a positive integer; an atomic percentage of the filler component in mth layer of the doped diamond-like carbon composite film is (n−m+1) times xₙ, wherein m is an integer in a range from 1 to n.

5. The mold as claimed in claim 1, wherein the filler component is selected from a group consisting of chromium, titanium, zinc, chromium-titanium alloy, chromium nitride, titanium nitride, zinc nitride and any combination thereof.

6. The mold as claimed in claim 1, wherein a thickness of each doped diamond-like carbon layer is in a range from 1 nanometer to 30 nanometers.

7. The mold as claimed in claim 1, wherein a thickness of the doped diamond-like carbon composite film is in a range from 5 nanometers to 900 nanometers.

8. The mold as claimed in claim 7, wherein the thickness of the doped diamond-like carbon composite film is in a range from 30 nanometers to 450 nanometers.

9. The mold as claimed in claim 1, wherein a thickness of the undoped diamond-like carbon film is in a range from 1 nanometer to 10 nanometers.

10. The mold as claimed in claim 9, wherein a thickness of the undoped diamond-like carbon film is in a range from 2 nanometers to 5 nanometers.

11. The mold as claimed in claim 1, wherein the main body is comprised of a material selected from a group consisting of ferrum-carbon-chromium alloy, ferrum-carbon-chromium-molybdenum alloy, ferrum-carbon-chromium-vanadium-molybdenum alloy, and ferrum-carbon-chromium-vanadium-silicon-molybdenum alloy.
